(19) United States
(12) Patent Application Publication
(10) Pub. No.: US 2009/0259599 A1
(43) Pub. Date: Oct. 15, 2009

(54) METHOD AND APPARATUS FOR ANALYZING INDIVIDUAL AND COMPARATIVE RETURNS ON ASSETS

(76) Inventor: Steven M.H. Wallman, Great Falls, VA (US)

Correspondence Address: KENYON & KENYON LLP, 1500 K STREET N.W., SUITE 700, WASHINGTON, DC, 20005, US

(21) Appl. No.: 12/428,331

(22) Filed: Apr. 22, 2009

Related U.S. Application Data
(63) Continuation of application No. 09/573,230, filed on May 19, 2000, now abandoned.

(51) Int. Cl. G06Q 40/00

(52) U.S. Cl. 705/36 R; 705/35

(57) ABSTRACT

A computer implementable graphical method and apparatus for presenting historical returns of one or more assets, liabilities, and/or indices is disclosed. A computer can plot an historical returns (in percentages) versus historical time for one or more user selectable assets, liabilities, or indices. Each historical return can be obtained by subtracting an historical price from a current price, and dividing the result by the historical price to obtain a ratio, which is multiplied by 100 percent. Alternatively, the historical return can be obtained by applying the described technique to a moving average historical price.

### CROSS-REFERENCE TO RELATED APPLICATIONS

This is a continuation of application Ser. No. 09/573,230 filed 19 May 2000, the content of which is incorporated herein by reference in its entirety.

### BACKGROUND OF THE INVENTION

The present invention relates generally to methods for analyzing and displaying returns on assets or liabilities to consumers of financial information, including current and potential investors, securities analysts, securities broker-dealers, financial planners, and finance professionals. More particularly, the present invention relates to a method for analyzing and displaying returns on assets to consumers of financial information that may be implemented on a graphical user interface of a computer accessing databases of current and historical asset or liability values and/or index values for comparative performance analysis.

The absolute numbers of investors holding assets or liabilities, including securities and other instruments, is currently at an all-time high, at least in the United States. Moreover, the relative percentage of U.S. citizens holding such assets or liabilities for investment purposes (excluding, for example, homeowners holding their primary home) is also at an all-time high. Furthermore, trends seem to point to both of these numbers increasing in the future. In addition, if the government privatizes even part of Social Security, as is currently being debated, these numbers will soar astronomically.

Unfortunately, many of the newer investors do not understand some of the basics of investing. These newer investors must therefore digest significant amounts of complex financial information to grapple with becoming responsible and able investors. Consequently, as more and more people invest in assets and liabilities, such as instruments including stocks and other securities, there is an increasing demand for concise and accurate presentations of large amounts of financial information.

In particular, many investors seek to analyze past returns on such assets or liabilities to determine whether to buy, sell, or hold a particular investment. While perusing large numbers of potential investments, newer investors, in particular, must quickly determine whether a potential investment meets their needs. Investors increasingly demand comparative analysis, particularly analysis that allows consumers of financial information to compare the historical returns of one asset or liability against returns of another asset or liability.

Techniques for presenting and comparing historical returns of assets exist, but are seriously limited in their usefulness, which to date investors have been forced to accept. For example, a common method of presenting and comparing historical returns is to normalize the value of two assets and to plot the changes in these values over time. This method is depicted in FIG. 1, which presents the normalized values of Dow Chemical 1 and the S&P 500 2, which are normalized to the same value as of February 1998. The relative change in value from the normalized price is then plotted from the starting point (February 1998) to a more recent time (in this case, February 2000).

This method has several limitations. First, a reader must interpolate to account for different holding periods or different buy prices. The reader interpolates returns for a particular asset over a particular period from the method by dividing the value of the asset at the end of the period by the value of the asset at the beginning of the period. For example, if the value of asset B at the time of the beginning of the plot is Value=b1 and the value of asset B at the time of the end of the plot is Value=b2, then the returns on asset B must be interpolated from the following equation:

((b2−b1)/b1)×100%=((b2/b1)−1)×100%

If the reader is interested in the returns at any other point, or multiple points, the same calculation must be performed each time. This calculation limits the rate at which a reader can analyze potential investments.

Another problem with these plots is that the moment in time selected for the normalization point significantly affects the relative performance of the asset in question relative to another asset to which the former asset is being compared. Particularly for highly volatile assets, the time during the day that is selected as the normalization point significantly impacts whether the asset is performing well or not. As the market has become more volatile, this problem becomes more significant, and the resulting plots are less and less useful.

Moreover, the meaning of these plots can be misleading. For example, it would appear that the investment represented by the curve at the top (Dow Chemical) was a better investment than the market as represented by the S&P 500 index, but in fact it depends when Dow Chemical was purchased. Those investors who purchased Dow Chemical before April 1999, and held until at least May 1999, outperformed the market. Those investors who bought after April 1999 (right side of vertical line 3) and sold before, or held until January 2000, under-performed the market.

Second, a reader can interpolate comparative returns only if the reader repeats that activity for the second asset or index. Even then, however, the comparison works only if the reader is comparing the gain in value of the assets from the time at which the normalized value of the first asset is equal to the second asset (e.g., t=0).

Another common method for presenting returns is to plot normalized historical annual returns over time, as shown in FIG. 2 for Dow Chemical 21 and the S&P 500 index 22. This method also has several limitations, however. First, it tells the reader only what each asset's annual return was over a particular time interval, typically one year. This information is meaningful to a reader only if the reader is interested in the returns for the exact time interval presented in the graph. This is a severe limitation because investors do not typically hold assets for the exact time intervals that are presented in such graphs. In fact, investors typically are faced with the prospect of making decisions based on annual returns measured from specific dates in time, such as January 1, or the beginning of each quarter, yet few investors actually own securities purchased on these particular dates. Second, the graph does not allow for comparative analysis of returns, unless the reader is interested only in the returns of both assets at particular points in time.

The present invention is therefore directed to the problem of analyzing and displaying historical returns of assets or liabilities in a way that allows consumers of financial information to immediately comprehend the historical returns on any one particular asset or liability and to easily compare it to the returns of other assets or liabilities for the time frame desired.

### SUMMARY OF THE INVENTION

The present invention solves this problem by analyzing and displaying historical returns in an easy-to-read format. According to one exemplary embodiment of the present invention, historical time is shown along one axis, such as the X-axis and return is shown along another axis, such as the Y-axis. In addition, the investments are normalized to each other at the present time so that at any point in the past, the two investments can be directly compared.

### BRIEF DESCRIPTION OF THE DRAWINGS

FIG. 1 depicts a traditional method for presenting historical prices of an asset and for comparing the prices of one asset to another in which the historical prices of the two assets are normalized to an identical value, which for exemplary purposes depicts Dow Chemical stock as compared to the S&P 500 index.

FIG. 2 depicts another traditional method for presenting historical annual returns of an asset and for comparing the annual returns of one asset to another in which the historical annual returns of the two assets are normalized to an identical value, which for exemplary purposes depicts Dow Chemical stock as compared to the S&P 500 index for the same time frame as depicted in FIG. 1.

FIG. 3 depicts an exemplary embodiment of a method according to the present invention for presenting absolute returns of an investment, in which the plot depicts time increasing from right to left, and which for exemplary purposes depicts Dow Chemical stock as compared to the S&P 500 index for the same time frame as depicted in FIG. 1.

FIG. 4 depicts another exemplary embodiment of a method according to the present invention for presenting absolute returns of an investment, in which the plot depicts time increasing from left to right, and which for exemplary purposes depicts Dow Chemical stock as compared to the S&P 500 index for the same time frame as depicted in FIG. 1.

FIG. 5 depicts an exemplary embodiment of a method according to the present invention for presenting annualized returns of an investment, in which the plot depicts time increasing from right to left, and which for exemplary purposes depicts Dow Chemical stock as compared to the S&P 500 index for the same time frame as depicted in FIG. 1.

FIG. 6 depicts another exemplary embodiment of a method according to the present invention for presenting annualized returns of an investment, in which the plot depicts time increasing from left to right, and which for exemplary purposes depicts Dow Chemical stock as compared to the S&P 500 index for the same time frame as depicted in FIG. 1.

FIG. 7 depicts an exemplary embodiment of a method according to the present invention for presenting absolute returns (based on a three month moving average) of an investment, in which the plot depicts time increasing from right to left, and which for exemplary purposes depicts Dow Chemical stock as compared to the S&P 500 index for the same time frame as depicted in FIG. 1.

FIG. 8 depicts another exemplary embodiment of a method according to the present invention for presenting absolute returns (based on a three month moving average) of an investment, in which the plot depicts time increasing from left to right, and which for exemplary purposes depicts Dow Chemical stock as compared to the S&P 500 index for the same time frame as depicted in FIG. 1.

FIG. 9 depicts an exemplary embodiment of a method according to the present invention for presenting annualized returns (based on a three month moving average) of an investment, in which the plot depicts time increasing from right to left, and which for exemplary purposes depicts Dow Chemical stock as compared to the S&P 500 index for the same time frame as depicted in FIG. 1.

FIG. 10 depicts another exemplary embodiment of a method according to the present invention for presenting annualized returns (based on a three month moving average) of an investment, in which the plot depicts time increasing from left to right, and which for exemplary purposes depicts Dow Chemical stock as compared to the S&P 500 index for the same time frame as depicted in FIG. 1.

FIG. 11 depicts an exemplary embodiment of an apparatus for implementing the method of the present invention.

### DETAILED DESCRIPTION

Although the embodiments of the present invention are described herein in terms of securities and indices, the present invention is equally applicable to any instrument, asset and/or liability, including, but not limited to equities, securities, government bonds, Treasury-bills, shares in mutual funds, shares in investment trusts, derivatives, investment contracts, bearer bonds, mutual funds, bank notes, insurance contracts, letters of credit, etc. Furthermore, although the embodiments of the present invention are sometimes described in terms of dollars, the present invention is equally applicable to any currency or denomination or other variable that is deterministically convertible to a number of shares.

The present invention provides, inter alia, a quick and quickly comprehendible technique for graphing returns on assets or liabilities, which can be readily implemented on a computer and transmitted to a potential investor over a computer network, such as the Internet. Thus, the present invention makes possible an interactive web site providing comparative analysis of stocks or other investments to potential investors, which comparative analysis can be readily understood even by novice investors.

The present invention can enable comparative plots of returns on assets or liabilities that can be accomplished even if the historical periods of the assets or liabilities are held for different times, which can thereby enable performance comparisons that otherwise require interpolation by the reader. Removing the requirement for interpolation can enable novice investors to quickly analyze large amounts of potential investments and thereby simplify their investment decisions.

According to one exemplary embodiment of a method according to the present invention, the X-axis is made to intersect the Y-axis at zero (0), where zero (0) means that the return from a point in historical time until the present is zero (0) or, put another way, the asset's or index's current value is precisely 100% of its historical value. Traditionally, the values of an asset are normalized to a prior point in time, e.g., Jan. 1, 1990, and then compared as to the normalized value. In contrast, the present invention performs backward normalization enabling comparisons of assets whose origins (i.e., purchase date) are not the same. An advantage of this aspect of the present invention is that it can allow readers to readily obtain an historical return of an asset or index from any particular point in time, not just a predetermined one, two, or five year return, which are normally provided. As every plot can include time from the present backward to a time when the asset came into existence (which of course can be limited to a most recent period for those assets that have been in existence for a long time), the plot can include the period in which an investor is interested. This is due to the fact that the plot is normalized from the present time backwards rather than from a specific point in time and then plotted with reference to that time forward. By selecting the present time as the normalization point, one can include all pertinent data backwards, whereas in the prior art the normalization point limits the period that one can plot.

According to one aspect of the present invention, the current value of the asset or liability in question is used as the normalization value from which all other values are calculated. Therefore, all values depicted in the plot are normalized to current valuations, thereby enabling a reader to determine the return on the investment in question. Moreover, as the time is depicted from the current point in time backward to the beginning of the investment, for example, or backward for a predetermined period of time, such as 1, 3, 5, or 10 years, the resulting plot includes the periods of interest for most investors. Furthermore, as the data is plotted for the present day backwards, the plot likely includes one point of the period in question for a given investor and if the plot includes a significant period of time, the plot also likely includes a second point of time in which the given investor is interested.

Another advantage is that the present invention allows readers to readily compare the returns of different assets or indices. As compared to the prior art, the present invention enables a reader to view the relative rates of return without having to interpolate from plotted values.

### Absolute Returns Embodiment

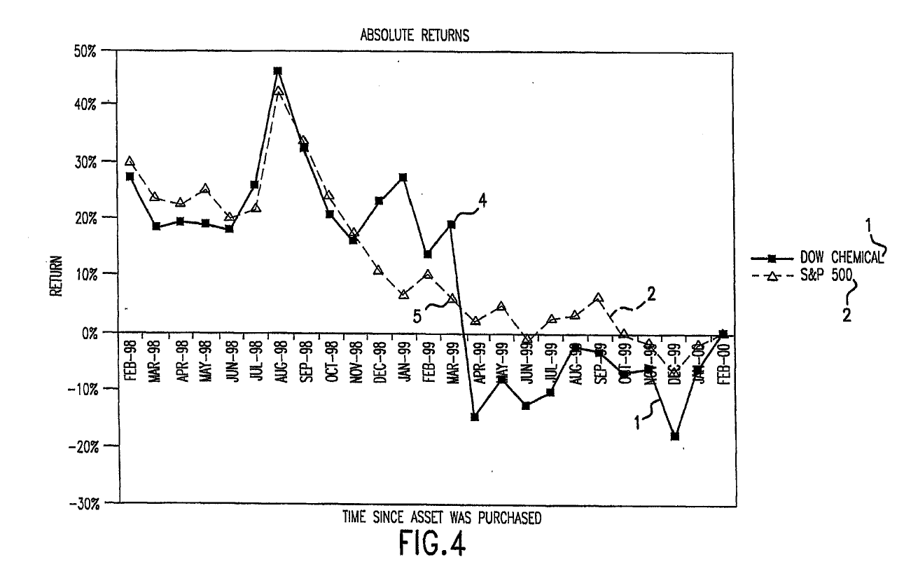

According to one exemplary embodiment of a method for graphing returns, any one asset's or index's returns are plotted along the X- and Y-axes as follows:
The price of the asset or the value of the index at each point in historical time (Pt−n) is subtracted from the current price (Pt) to yield a result, as follows: (Pt−Pt−n).
The result is divided by the historical price to arrive at the absolute return ratio as follows: R=(Pt−Pt−n/Pt−n).
The absolute return ratio is converted to an absolute return by multiplying by 100% as follows: Y=(R)−*100%.
This return is then plotted on the graph.
This process is repeated for different points—or every point—in historical time to yield the final graph. See, for example, FIG. 3, in which each square represents a historical price and the return for each historical price is calculated as set forth above. For example, in March 1999, Dow Chemical had an absolute return 4 of about 20% and the S&P 500 had an absolute return 5 of about 7%.
   Thus, for a current value of $100 and a point in time at which the value was $50, the return (Y) becomes Y=((100−50)/50)*100%=50%. For another previous point in time where the value was $25, the return (Y) becomes Y=((100-25)/25)*100%=75%. At the present time, as compared to the present time, the return is zero (0).

Any number of additional assets or indices can be added to the graph by repeating this process. For example, overlaid on this plot could be a plot of the Dow Jones 30 Industrials Index, the Russell 2000 Index, the NASDAQ Index, or any other market index or indices. Moreover, market sector indices can be overlaid as well, such as the Internet index, transportation, communications, financial index, etc. Further, the values for each of these additional assets or indices can be value-normalized such that, at the present time, the value of each additional asset or index equals the value of the original asset.

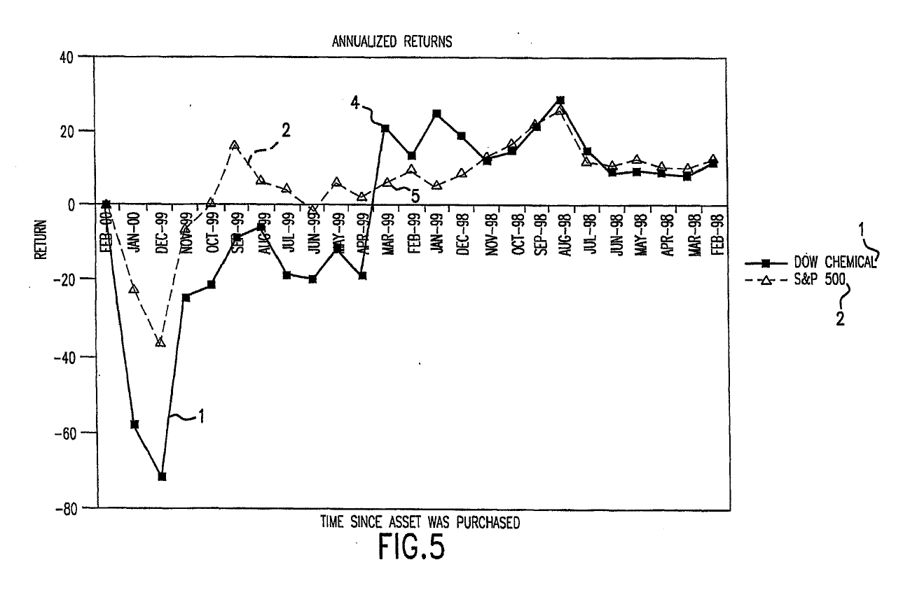

FIG. 4 depicts another exemplary embodiment of the graph of FIG. 3, but with the time axis reversed. The graph of FIG. 3 depicts time moving from right to left to emphasize the normalization point as being the present, however, the graph of FIG. 4 presents time in the more traditional format, i.e., moving from left to right.

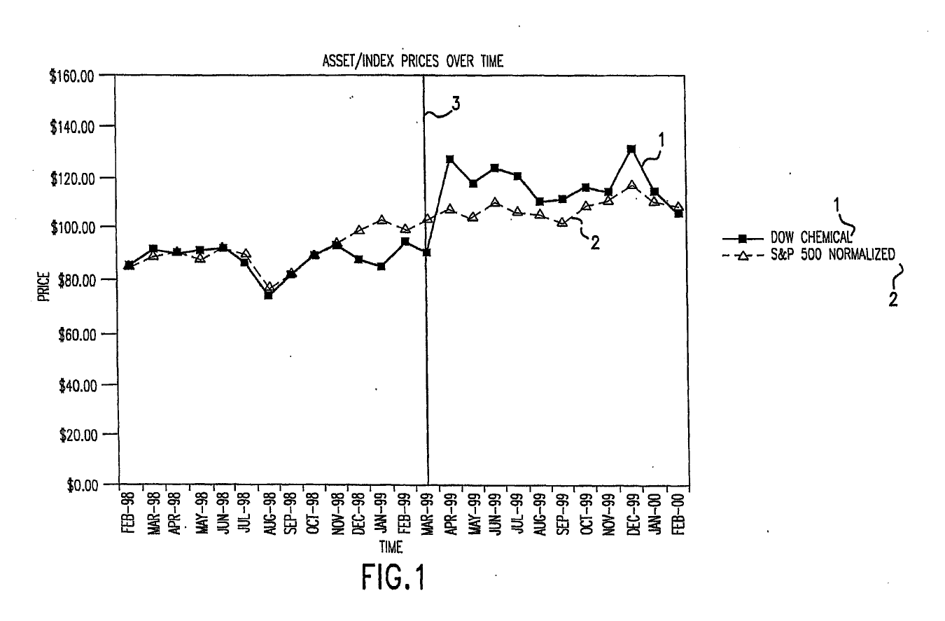

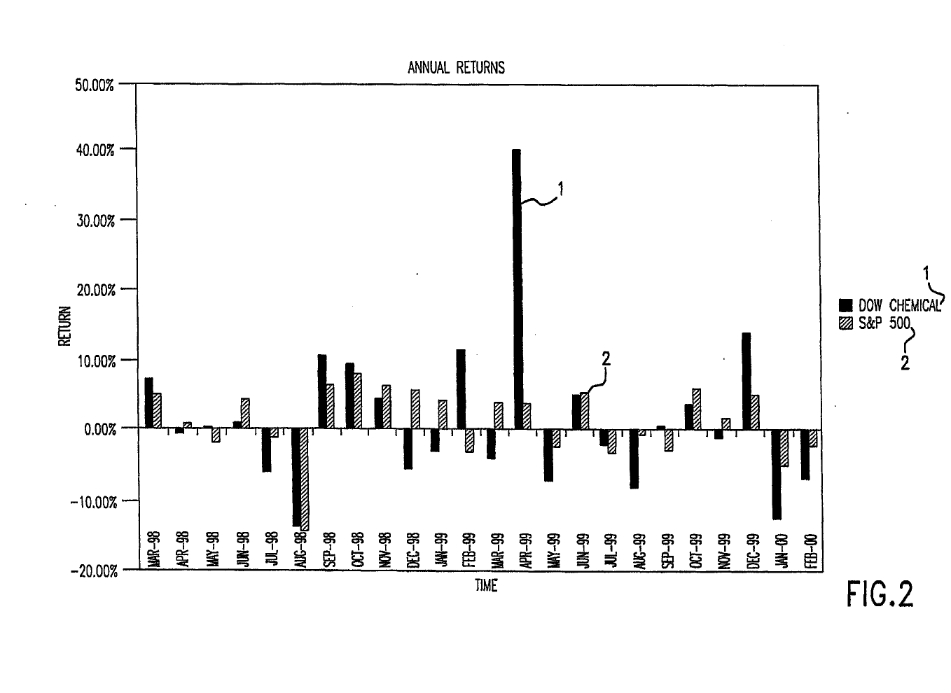

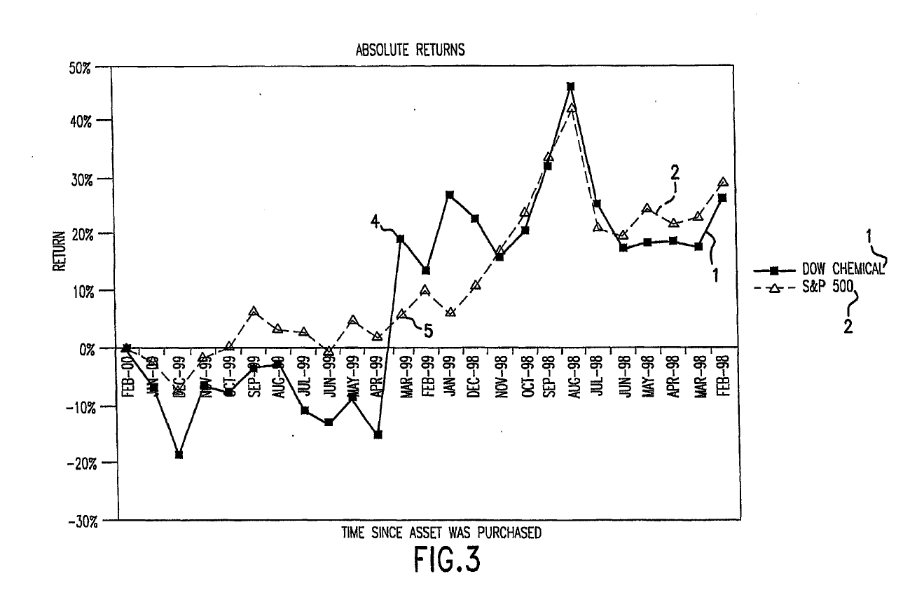

As evident from the plot of curve 1 for Dow Chemical in FIG. 4, while the asset value for Dow Chemical increased from approximately $85 to $110 during the period from February 1998 through February 2000 (see FIG. 1), the resulting graph shown in FIG. 4 has a generally decreasing slope over the same period. This inverted return graph results from the fact that the backwards normalization process of the present invention uses the present value against which all other values are measured rather than some arbitrarily-selected historical point in time. So historical values higher than the present value will have negative values for their return, whereas historical values lower than the present value will have positive values for their returns—in direct contradiction to traditional return calculations and displays.

For example, the backwards normalization method of the present invention uses Pt=$110, Pt−n=$135 (November 1999), which when applying the previously discussed formula, one obtains:

(Pt−Pt−n)/pt−nx 100=($110−$135)/$135×100=−18.52% Thus, the graph in FIG. 4 has a negative local minimum for November 1999 of about −19% despite the fact that this point was the highest value Dow Chemical reached during the period of interest.

Each of the plots from FIGS. 3-10 are calculated using the backwards normalization method of the present invention. FIGS. 3, 5, 7 and 9 employ an horizontal axis in which time decreases from left to right, whereas FIGS. 4, 6, 8 and 10 employ an horizontal axis in which time increases from left to right.

### Moving Average Embodiment

According to another aspect of the invention, a moving average return is plotted. Calculating the moving average is performed in the known manner using a predetermined averaging period, such as 90-days, 6-months, etc.

One possible technique for calculating the moving average is as follows. Once an averaging period is chosen, the prices in the current averaging period are summed (e.g., p₀+p₋₁+p₋₂, in which case the averaging period is three months if the prices are monthly, three days if the prices are daily, etc.); the resulting sum is divided by the number of samples (e.g., three) used to calculate it; and the result is a current moving average price (p_{0mavg}). A similar average calculation is performed at each desired point in time, using the price (pᵢ) at that point in time (tᵢ) and other prices, either just before (e.g., pᵢ+pᵢ₋₁+pᵢ₋₂) or just after (e.g., pᵢ₊ₚᵢ₊₁+pᵢ₊₂) or both just before and just after the price at the point in time (e.g., pᵢ+pᵢ₊₁p₊₋₁). The same number of price samples at each point in time are averaged in the same manner to obtain an moving average price (p_{imavg}) for each point in time.

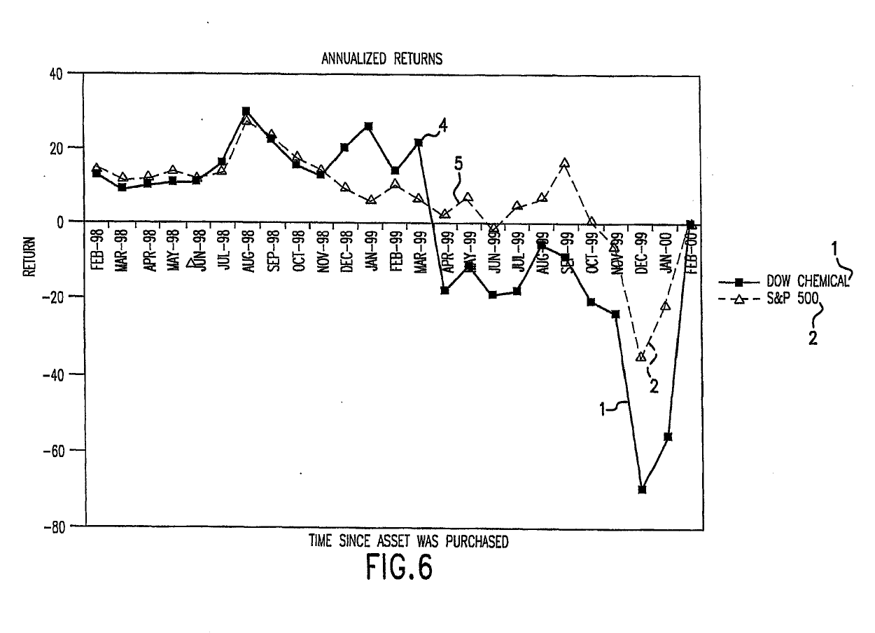

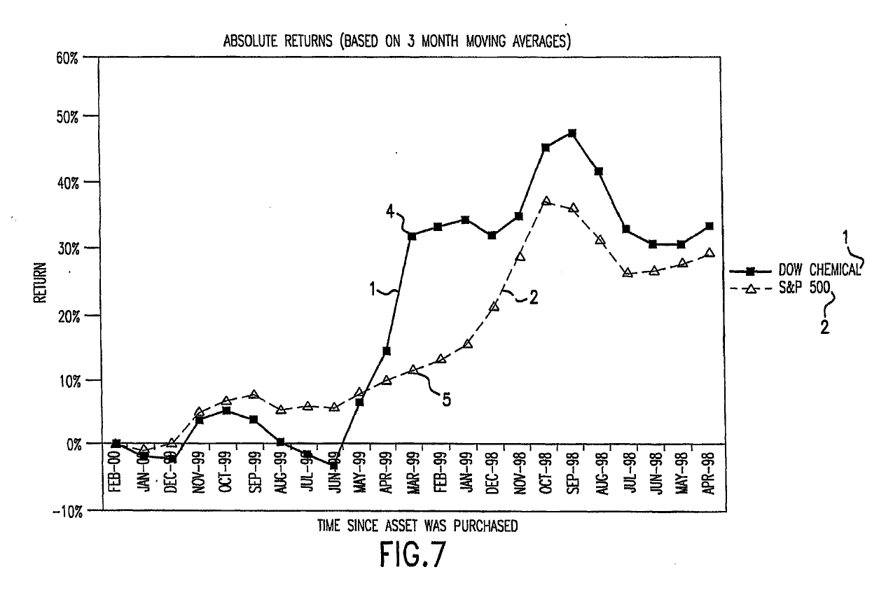

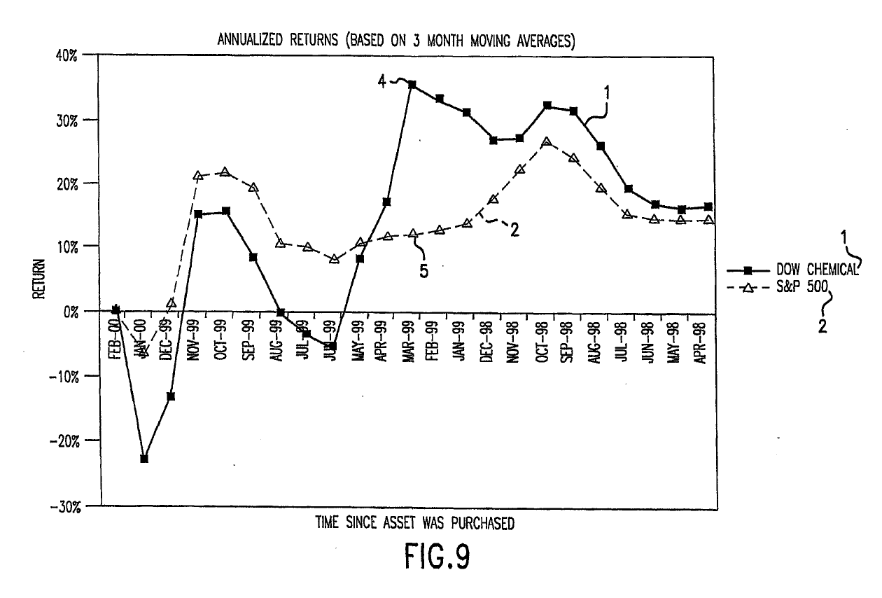

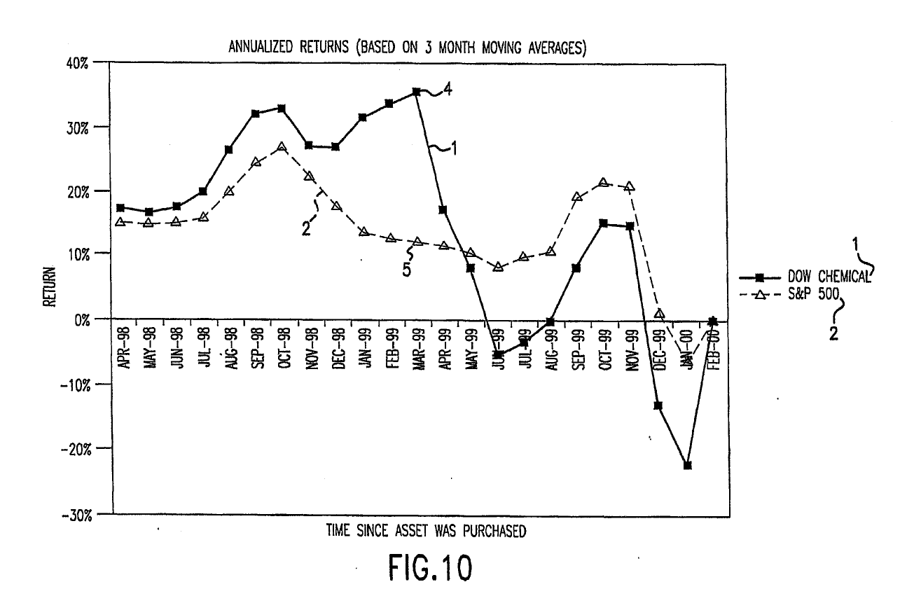

Any technique for calculating a moving average, however, is suitable for the purposes herein. The moving average return is then plotted along the X- and Y-axes as follows:
For any point in historical time (t−n), an historical moving average price of the asset (MAPt−n) is subtracted from the current moving average price (MAPt) to yield a result, as follows: (MAPt−MAPt−n).
The result is divided by the corresponding historical moving average price (MAPt−n) to arrive at a moving average return ratio, as follows: Rma=((MAPt−MAPt−n)/MAPt).
The return ratio is converted to a moving average return by multiplying by 100% as follows: Yma=(Rma)−*100%.
The return is then plotted on the graph.
   This process is repeated for selected points—or every point—in historical time to yield the final graph. See, for example, FIG. 7, which plots the same data in FIG. 3, but applies a moving average to the data to smooth out the fluctuations, which are otherwise drastic near the present time. See also, FIG. 9, which plots the same data in FIG. 5, but applies a moving average to the data. FIG. 10 depicts another exemplary embodiment of the graph of FIG. 9, but with the time axis reversed. The graph of FIG. 9 depicts time moving from right to left, whereas the graph of FIG. 10 presents time moving from left to right.

An advantage of this embodiment of the invention is that it reduces the variations in recent returns, increasing the precision of the graph for recently purchased assets. If returns are normalized relative to the last price (or current price), there can be large swings in the investment at the present time portion of the graph. Using the moving average rather than price smoothes out the large fluctuations.

Shown in FIG. 7 is an historical percentage return based on a three month moving average price is plotted on the Y-axis and historical time (in years) on the X-axis. In the exemplary graph shown in FIG. 7, using a normalization point of February 2000, the 3 month moving average return for securities issued by the Dow Chemical Company is about 33% since March 1999 and about 48% since September 1998. This embodiment damps the large fluctuations that would otherwise exist at the portion of the plot near February 2000.

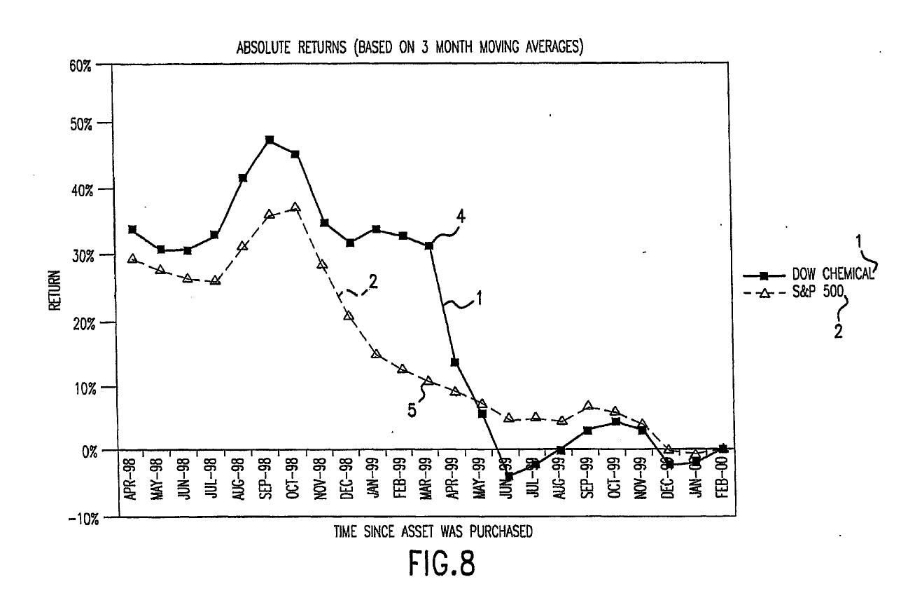

FIG. 8 depicts another exemplary embodiment of the graph of FIG. 7, but with the time axis reversed. The graph of FIG. 7 depicts time moving from right to left, whereas the graph of FIG. 8 presents time moving from left to right.

Other techniques for avoiding the large fluctuations that may result include increasing the averaging period, and/or cutting the graph off for a predetermined period before the present (such as one day, one hour, etc.). Each of these techniques requires a tradeoff of the loss of potentially interesting and perhaps relevant information.

### Annualized Returns

Another exemplary embodiment of the above method includes graphing annualized returns, an example of which is depicted in FIG. 3. Annualizing can convert a return ratio to an effective annual compounded return. Thus, annualizing can be applied to any return ratio, including an absolute return ratio and/or a moving average return ratio. With respect to an absolute return ratio, one possible technique for calculating an annualized return (i.e., annualizing) is as follows:

annualized return=100%*((((current price-historical price)/historical price)̂(12/number of months between the historical price and the current price))−1)

More generally, an annualized return can be calculated as:

annualized return=100%*((((Return ratio)̂(12/number of months between the historical price and the current price))−1)

In the case of a moving average return ratio, the time period between the current price and either the beginning, middle, or end historical price can be used.

Any technique for calculating the annualized return, however, is suitable for the purposes herein. Regardless of how an asset's, liability's, or index's annualized returns are calculated, the annualized returns can be plotted, and the process repeated for selected points—or every point—in historical time to yield the final graph. See, for example, FIG. 5, in which each square represents a data point at which the annualized return of the underlying asset is calculated as set forth above. By way of further example, from March 1999 to February 2000, Dow Chemical had an annualized return 4 of about 20% and the S&P 500 had an annualized return 5 of about 7%.

FIG. 6 depicts another exemplary embodiment of the graph of FIG. 5, but with the time axis reversed. The graph of FIG. 5 depicts time moving from right to left, whereas the graph of FIG. 6 presents time moving from left to right.

Although the above technique is discussed in terms of annualized returns, the above technique can be modified to present returns for any other desired time period, such as monthly, daily, etc.

### Exemplary Embodiment of Apparatus

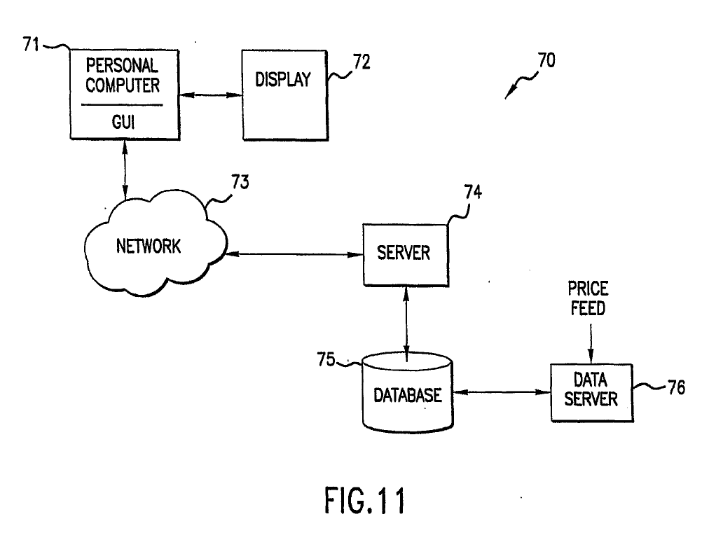

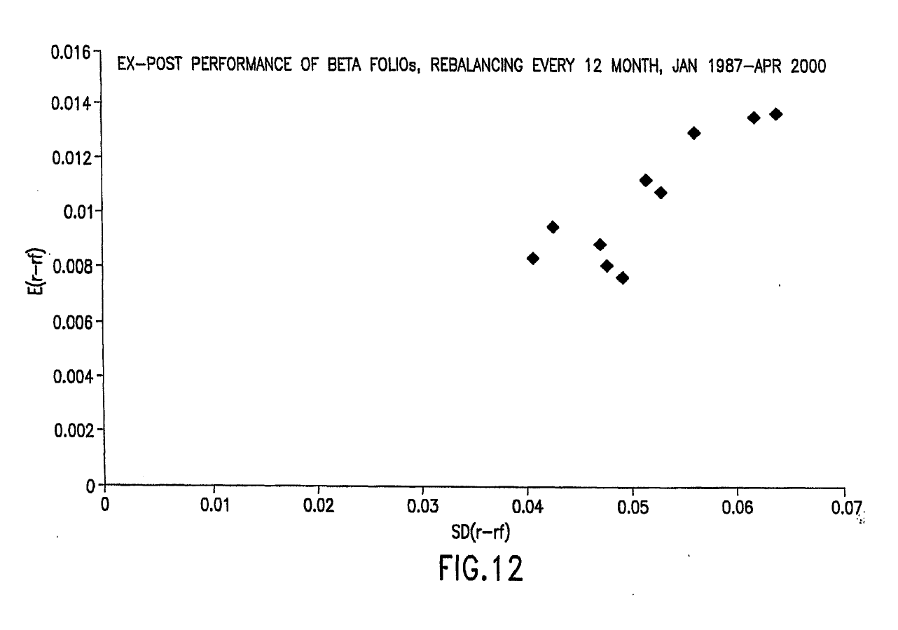

Referring to FIG. 11, shown therein is an exemplary embodiment of an apparatus 70 according to the present invention. The exemplary embodiment 70 includes a computer 71, which can be embodied in a personal computer, desktop computer, laptop, palm pilot, PDA, pager, wireless telephone, wired telephone, facsimile, etc., which can include a processor, memory, instructions, and an input/output device. The computer 71 is coupled either directly or indirectly (as shown) to a database 75. The database 75 is a static and/or continuously updated database of current asset prices and index values, as well as historical asset prices and index values.

In this embodiment, the computer 71 is coupled to a server 74 over a computer network 73, such as the Internet. A database 75 accessible by the server 74 contains the present and historical price information from which the above-mentioned plots are created. Another data server 76 (or the same server) receives continuous data feeds from the market and updates the database 75.

Although the server is described in the singular for simplicity of description, the “server” is preferably embodied as a plurality of data processing machines that form a common hardware platform. As is consistent with usage in the art, however, these plural server machines are referred to collectively as a “server” (singular).

The processor controlling the computer 71 can be a general-purpose microprocessor, such as the Pentium series microprocessor manufactured by the Intel Corporation of Santa Clara, Calif. In another embodiment, the processor can be an Application Specific Integrated Circuit (ASIC), which has been designed to implement in its hardware and/or firmware at least a part of a method in accordance with an embodiment of the present invention.

The memory can be any device capable of storing analog or digital information, such as a hard disk, Random Access Memory (RAM), Read Only Memory (ROM), flash memory, a compact disk, a magnetic tape, a floppy disk, and any combination thereof.

The input/output (I/O) device can be an audio and/or visual device, including, for example, a monitor, display, keyboard, keypad, touch pad, pointing device, microphone, speaker, video camera, camera, scanner, printer, and/or port to which an I/O device can be attached or connected.

Computer 71 can provide a graphical user interface, which includes, for example, a web browser executing on the computer 71 accessing web pages from a server 74 over a computer network 73, such as the Internet. The combination of these elements enables the user to select and navigate through various web pages and enter queries into the database via web pages that result in the above-described plots. In this embodiment, a graphical user interface executes on the personal computer, and interacts with the user to create and render (i.e., make perceptible) the desired graphs, such as depicted in FIGS. 3-10.

The database can be any device capable of storing and retrieving information based on a query sent from the computer. An example of such a database is manufactured by the Oracle Corporation. If the database includes continuously updated price information, the present invention can provide a continuously updated presentation of the returns of the displayed investments.

The exemplary apparatus 70 produces an historical return graph for any asset, index, or combination of assets and indices that the user selects, as set forth in FIGS. 3-10, for example. The graph is then rendered on the input/output device.

The personal computer 71 is coupled to the computer network 73, such as the Internet, via dial-up modem, cable modem or local area network, to name only a few. In this exemplary embodiment, the personal computer accesses a predetermined web site that includes historical price information for most securities, as well as feeds of updated price information of the same or other securities.

The web site enables a user to specify a particular security by entering the trading symbol of the security into a search engine that searches the database for the desired security. If the user does not know the specific trading symbol, the search engine enables the user to enter what information the user knows and the search engine displays a list of possible securities. Such search engines are well known in the art.

The price information stored in the database is then converted to the plots discussed above. The user may specify other securities that can be overlaid on the same plot or other standard industry market indices, such as the S&P 500, Dow Jones 30 Industrials, Russell 2000, etc., whose performance is plotted in the same way for instant comparative analysis.

The exemplary apparatus allows the user to select any combination of assets and/or indices and then produces the graph of historical returns. Graphs of multiple assets and/or indices may be overlaid on top of each other for comparative analysis.

The exemplary embodiment of the present invention provides a method of presenting historical returns of an asset and comparing them to the returns of other assets. The method presented herein is particularly useful when implemented on a graphical user interface of a computer. The method enables a rapid display and immediate comprehension of an investment's performance for any given time frame. Thus, the present invention provides a general, intuitive and easily understood format for analyzing large amounts of potential investments.

The present invention includes an apparatus for rendering returns on investments in a format easily understandable to even a novice investor. Thus, the present invention makes possible a method for doing business on the Internet, in which a dedicated web site provides the above-mentioned plots in response to user queries regarding specific securities and investments. By centralizing the data feeds and the historical database, the cost for such a business can be reduced to the point where advertisements, for example, support the provision of free services to users. Alternatively, this service could be provided as an adjunct to other investment services, such as an investment portfolio creation and management service.

An exemplary embodiment of a method for analyzing a plurality of assets/liabilities includes providing a web site on a computer network, at which web site a user may specify one or more of assets/liabilities of which the user is desirous of analyzing. The method also includes calculating a current value normalized return graph by normalizing all historical values of the one or more assets/liabilities over a predetermined period to a most recent value of one of the assets/liabilities. According to this embodiment, the current value normalized return graph is then displayed to the user via a web browser executing on a computer of the user. In addition, the returns plotted can be further adjusted or normalized for inflation, a return's relation to an index, or some other measure, as opposed to simply absolute returns.

The selection of the axes in the various embodiments to plot returns and time can be modified, depending upon the preference of the reader. The choice of the X-axis for time and the Y-axis for returns is merely used as a convenience. Moreover, a third axis could be used for other information, such as other investment options, tax consequences, interest rates, etc., without departing from the scope of the invention.

The above embodiments display returns on an investment since various historical times with respect to a predetermined value (such as, for example, the current time) and plot the returns on one axis and time on the other axis of a graph. In addition, historical values of a market index can be normalized to a recent value of the market index, and their corresponding returns plotted on the same graph. It is also possible to normalize the investment to a predetermined value of the market index, calculate the corresponding returns, and graph these returns. Moreover, returns for multiple investments and/or market indices can be included on a single graph, despite varying holding periods for each investment.

Although the present invention has been described above with reference to securities assets, the present invention is applicable to other assets in which an understanding of historical returns is useful, including, but not limited to, shares in mutual funds, commodities, bonds, real-estate, art, antiques, etc. Furthermore, although the above invention has been described with reference to particular embodiments, the scope of the present invention is not limited to the disclosed embodiments.

What is claimed is:

1. A computer-implemented method for presenting returns comprising:
using a processor to perform a backwards normalization for each of a plurality of historical values and a present value, said backwards normalization including for each of the plurality of historical values:
subtracting the historical value from the present value to obtain a result;
dividing the result by the historical value to obtain a ratio;
converting the ratio to a return; and
plotting the return on a graph, one axis of which depicts returns and another axis of which depicts time.

2. The method according to claim 1, wherein said plotting the return on a graph comprises using a horizontal axis to depict time as time decreases from left to right and a vertical axis to depict the return.

3. The method according to claim 1, wherein an historical value that is higher than the present value is depicted with a negative value and an historical value that is lower than the present value is depicted with a positive value.

4. The method according to claim 2, wherein an historical value that is higher than the present value is depicted with a negative value and an historical value that is lower than the present value is depicted with a positive value.

5. The method according to claim 1, wherein said plotting the return on a graph comprises using a horizontal axis to depict time as time increases from left to right.

6. The method according to claim 5, wherein an historical value that is higher than the present value is depicted with a negative value and an historical value that is lower than the present value is depicted with a positive value.

7. An apparatus for displaying information relating to at least one investment comprising:
a database storing historical information regarding at least the one investment; and
a processor coupled to the database and preparing a return graph based on the historical information, said processor, for a plurality of points in time, performing a backwards normalization by:
subtracting an historical value from a current value to obtain a result;
dividing the result by the historical value to obtain a ratio;
converting the ratio to a return; and
plotting the return on a graph, one axis of which is returns and another axis of which is time.

8. The apparatus according to claim 7, further comprising an input/output device coupled to the processor, said input/output device receiving the return graph from the processor, and plotting the return graph.

9. The apparatus according to claim 8, wherein said input/output device plots the return graph so that a horizontal axis depicts time as time decreases from left to right.

10. The apparatus according to claim 9, wherein an historical value that is higher than the present value is depicted with a negative value and an historical value that is lower than the present value is depicted with a positive value.

11. The apparatus according to claim 7, further comprising a market data feed interface via which the database receives current prices for at least the one investment.

12. The apparatus according to claim 8, wherein said input/output device receives inputs from a user regarding one or more assets/liabilities and one or more indices the user wishes to analyze.

13. An apparatus for analyzing a return on a security comprising:
a server coupled to a computer network and hosting a web site, said web site accessible to a user over the computer network, said web site including a query field in which the user may enter at least one security which the user desires to analyze, said server including a processor;
a database coupled to the server and storing current and historical values of a plurality of securities;
said processor preparing a return graph for the at least one security specified by the user in the query field on the web site using the current values and historical values of the plurality of securities, said processor, for a plurality of points in time, performing a backwards normalization by:
subtracting an historical value from a current value to obtain a result;
dividing the result by the historical value to obtain a ratio;
converting the ratio to a return; and
plotting the return on a graph, one axis of which is returns and another axis of which is time.

14. The apparatus according to claim 13, further comprising a market data feed interface via which the database receives current values of the plurality of securities.

15. The apparatus according to claim 13, wherein the server transmits the return graph to the user over the computer network for display in a web browser executing on the user's computer.

16. A method for analyzing a plurality of assets/liabilities comprising:
providing a web site on a computer network at which web site a user may specify a particular one or more of the plurality of assets/liabilities of which the user is desirous of analyzing;
calculating a current value backwards normalized return graph by backwards normalizing all historical values of the particular one or more of the plurality of assets/liabilities over a predetermined period relative to a most recent value of one of said particular one or more of the plurality of assets/liabilities;
displaying the current value backwards normalized return graph to the user via a web browser executing on a computer of the user; and
displaying the current value backwards normalized return graph.

17. The method according to claim 16, further comprising overlaying a current value backwards normalized return graph for one or more market indices on the current value backwards normalized return graph for the particular one or more assets/liabilities, wherein said current value backwards normalized return graph of the one or more market indices is backwards normalized to a same time to which said particular one or more of the plurality of assets/liabilities is backwards normalized.

18. A computer-implemented method for displaying returns on an investment comprising:
backwards normalizing by a processor a plurality of historical values of the investment to a most recent value of the investment;
plotting by the processor the backwards normalized historical values on one axis of a graph wherein the other axis of the graph includes time; and
displaying the plotted backwards normalized historical values.

19. The method according to claim 18, further comprising backwards normalizing a plurality of historical values of a market index to the most recent value of the investment and plotting the backwards normalized values of the market index on the graph.

20. A computer readable medium storing instructions that, when executed by a processor, cause the processor to perform a backwards normalization for each of a plurality of historical values by:
subtracting the historical value from a present value to obtain a result;
dividing the result by the historical value to obtain a ratio;
converting the ratio to a return; and
plotting the return on a graph, one axis of which depicts returns and another axis of which depicts time.
